(19) United States
(12) Patent Application Publication
(10) Pub. No.: US 2016/0094097 A1
(43) Pub. Date: Mar. 31, 2016

(54) ROTOR

(71) Applicant: TOYOTA JIDOSHA KABUSHIKI KAISHA, Toyota-shi (JP)

(72) Inventor: Shingo FUBUKI, Nissin-shi (JP)

(73) Assignee: TOYOTA JIDOSHA KABUSHIKI KAISHA, Toyota-shi (JP)

(21) Appl. No.: 14/868,769

(22) Filed: Sep. 29, 2015

(30) Foreign Application Priority Data
Sep. 29, 2014 (JP) 2014-198605

(51) Int. Cl. H02K 1/27

(52) U.S. Cl. CPC H02K 1/276

(57) ABSTRACT

A rotor includes a stacked body including stackable steel plates each formed by punching multiple magnet insertion holes in a steel plate with an insulation film at regular intervals in the circumferential direction and stacked in the rotational axis extending direction; and magnets disposed in the magnet insertion holes. A peripheral edge of each magnet insertion hole is provided with a projection projecting toward the magnet. The stackable steel plates constituting the stacked body include first and second stackable steel plates having the same shape, and are stacked such that the second stackable steel plate is in at least one of a rotation relation about the rotational axis and a turn-over relation with the first stackable steel plate such that the projections adjacent to each other in the circumferential direction are arranged at positions offset from each other in the stackable steel plate stacking direction.

### INCORPORATION BY REFERENCE

The disclosure of Japanese Patent Application No. 2014-198605 filed on Sep. 29, 2014 including the specification, drawings and abstract is incorporated herein by reference in its entirety.

### BACKGROUND OF THE INVENTION

1. Field of the Invention

The invention relates to a rotor including stackable steel plates stacked in the extending direction of the rotational axis, and magnets, each of the stackable steel plates being formed by punching multiple magnet insertion holes in a steel plate coated with an insulation film at regular intervals in the circumferential direction of the steel plate, and the magnets being disposed in the magnet insertion holes.

2. Description of Related Art

Japanese Patent Application No. 2013-258711 describes a technique pertaining to this technical field. In a rotor described in Japanese Patent Application No. 2013-258711, the peripheral edges of magnet insertion holes of stackable steel plates constituting a stacked body have projections. In the same cross-section orthogonal to the rotational axis, the projections are in contact with one of a first magnet and a second magnet that are adjacent to each other in the circumferential direction of the rotor (i.e., in the same cross-section of the rotor, one of the first magnet and the second magnet is in contact with the projections and the other one of the first magnet and the second magnet is not in contact with the projections). In this rotor, the positions at which the projections are in contact with the first magnet are offset in the axial direction of the rotor from the positions at which the projections are in contact with the second magnet located adjacent to the first magnet in the circumferential direction. This configuration of the rotor prevents the situation where an eddy current generated in the first magnet and an eddy current generated in the second magnet are short-circuited in the stacked body to generate a larger eddy current.

### SUMMARY OF THE INVENTION (US, CN)

In order to manufacture a rotor having a configuration in which projections that are in contact with one magnet are offset in the axial direction of the rotor from projections that are in contact with another magnet located adjacent to the one magnet in the circumferential direction of the rotor, it is necessary to prepare several kinds of stackable steel plates that differ in the forms of magnet insertion holes. The number of the kinds of the stackable steel plates corresponds to the number of times that the projections that are in contact with the one magnet are offset in the axial direction of the rotor from the projections that are in contact with the other magnet located adjacent to the one magnet in the circumferential direction. Using many kinds of stackable steel plates complicates the process of manufacturing the rotor.

The invention provides a rotor including less kinds of stackable steel plates, thereby making it possible to simplify the process of manufacturing the rotor while reducing eddy current losses.

A rotor according to an aspect of the invention includes a stacked body and magnets. The stacked body includes stackable steel plates stacked in the extending direction of the rotational axis. Each of the stackable steel plates is formed by punching multiple magnet insertion holes in a steel plate coated with an insulation film at regular intervals in the circumferential direction of the stackable steel plate. The magnets are disposed in the magnet insertion holes. The peripheral edge of each of the magnet insertion holes is provided with a projection that projects toward a corresponding one of the magnets. The stackable steel plates that constitute the stacked body include a first stackable steel plate and a second stackable steel plate. The first stackable steel plate and the second stackable steel plate have the same shape. The stackable steel plates are stacked such that the second stackable steel plate is in one of a first relationship, a second relationship, and a third relationship with the first stackable steel plate, and the projections located adjacent to each other in the circumferential direction are arranged at positions offset from each other in the stacking direction of the stackable steel plates. The first relationship is a relationship achieved by rotating the second stackable steel plate about the rotational axis from the position of the first stackable steel plate. The second relationship is a relationship achieved by turning over the second stackable steel plate from the position of the first stackable steel plate. The third relationship is a relationship achieved by rotating the second stackable steel plate about the rotational axis from the position of the first stackable steel plate and turning over the second stackable steel plate.

In the above aspect of the invention, each of the magnet insertion holes may include a pair of a first magnet insertion portion and a second magnet insertion portion that are adjacent to each other, and the projection in each of the magnet insertion holes may be located in one of the first magnet insertion portion and the second magnet insertion portion.

In the above aspect of the invention, each of the magnet insertion holes may include the first magnet insertion portion and the second magnet insertion portion that are in the form of slits obliquely extending inward from the outer peripheral side of the stackable steel plate such that each of the magnet insertion holes has an inverted V-shape having an apex oriented toward the rotational axis.

In the above aspect of the invention, each of the first magnet insertion portions may include a first magnet insertion half-part and a second magnet insertion half-part located inward of the first magnet insertion half-part, each of the second magnet insertion portions may include a third magnet insertion half-part and a fourth magnet insertion half-part located outward of the third magnet insertion half-part, the projections include a first projection and a second projection, the magnet insertion holes may include a pair of a first magnet insertion hole and a second magnet insertion hole that are located at positions symmetric with respect to the rotational axis, the peripheral edge of the first magnet insertion half-part of the first magnet insertion hole may be provided with the first projection that projects toward a corresponding one of the magnets, and the peripheral edge of the second magnet insertion half-part, the peripheral edge of the third magnet insertion half-part, or the peripheral edge of the fourth magnet insertion half-part of the second magnet insertion hole may be provided with the second projection that projects toward a corresponding one of the magnets.

In the above aspect of the invention, in the circumferential direction of each of the stackable steel plates, the first projections may be disposed in one half of the circumference of each of the stackable steel plates, and the second projections may be disposed in the remaining half of the circumference of each of the stackable steel plates, and each of the second projections may be located in the second magnet insertion half-part or the third magnet insertion half-part.

In the above aspect of the invention, the first projections and the second projections may be arranged alternately in the circumferential direction of each of the stackable steel plates, and each of the second projections may be located in the second magnet insertion half-part or the third magnet insertion half-part.

In the above aspect of the invention, the peripheral edge of each of the magnet insertion holes may be provided with a pair of the projections that are opposed to each other such that a corresponding one of the magnets is held between the projections.

In the above aspect of the invention, the length of the first projection may be shorter than the length of the second projection located in the second magnet insertion half-part or the third magnet insertion half-part.

According to the above aspect of the invention, it is possible to provide a rotor including less kinds of stackable steel plates, thereby making it possible to simplify the process of manufacturing the rotor while reducing eddy current losses.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a front view of a rotor according to a first embodiment of the invention;

FIG. 2 is an enlarged view of main portions of the rotor in FIG. 1;

FIG. 3 is a schematic diagram illustrating positions of projections in a stacked body;

FIG. 4 is an enlarged view of main portions of the rotor, illustrating magnet insertion holes;

FIG. 5A is a front view illustrating a state in which stackable steel plates illustrated in FIG. 1 are stacked;

FIG. 5B is a front view illustrating a state in which the stackable steel plates illustrated in FIG. 1 are rotated by 180°;

FIG. 5C is a front view illustrating a state in which the stackable steel plates in FIG. 1 are rotated by 180° and turned over;

FIG. 5D is a front view illustrating a state in which the stackable steel plates illustrated in FIG. 1 are turned over;

FIG. 6 is a front view of a rotor according to a second embodiment of the invention;

FIG. 7A is a front view illustrating a state in which stackable steel plates illustrated in FIG. 6 are stacked;

FIG. 7B is a front view illustrating a state in which the stackable steel plates illustrated in FIG. 6 are rotated by 180°;

FIG. 7C is a front view illustrating a state in which the stackable steel plates in FIG. 6 are rotated by 180° and turned over;

FIG. 7D is a front view illustrating a state in which the stackable steel plates illustrated in FIG. 6 are turned over;

FIG. 8 is an enlarged view of main portions of a rotor according to another embodiment of the invention;

FIG. 9 is an enlarged view of main portions of a rotor according to another embodiment of the invention; and

FIG. 10 is a front view of a rotor according to another embodiment of the invention, which differs in key positions from the other embodiments of the invention.

### DETAILED DESCRIPTION OF EMBODIMENTS

Hereinafter, rotors according to example embodiments of the invention will be described with reference to the accompanying drawings.

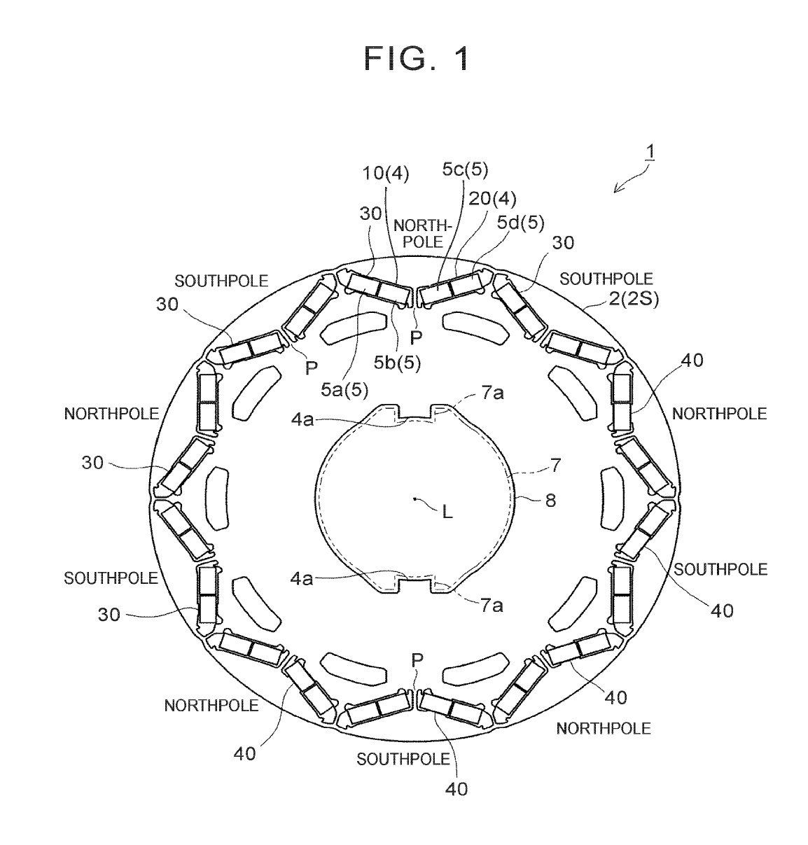

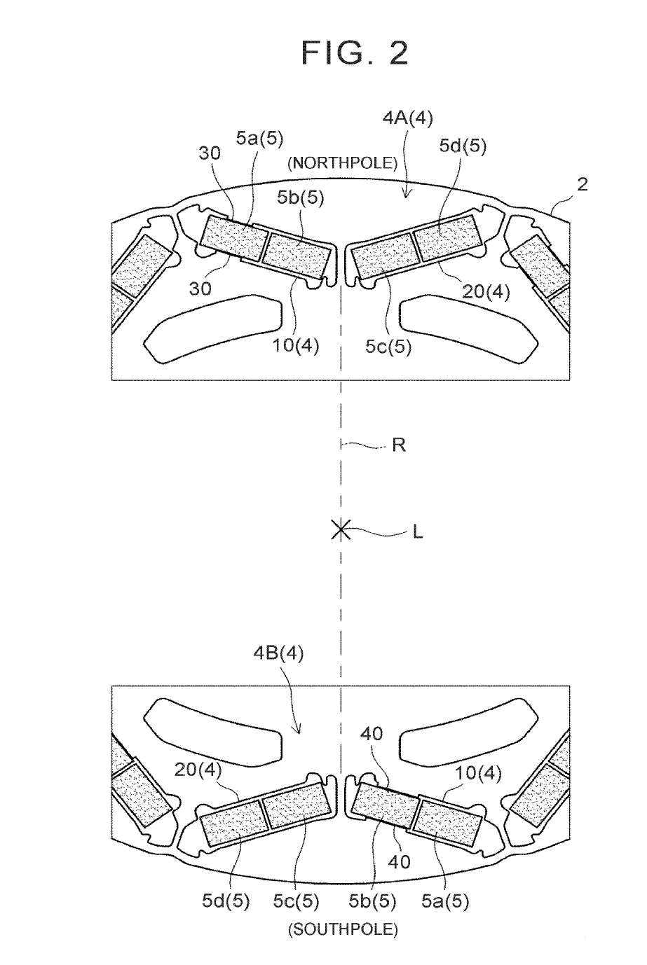

First, a first embodiment of the invention will be described. A rotor 1 illustrated in FIG. 1 and FIG. 2 is incorporated in a motor or a generator, which is used to drive a hybrid vehicle. The rotor 1 is employed not only in a hybrid vehicle but also in an electric vehicle or a fuel cell vehicle.

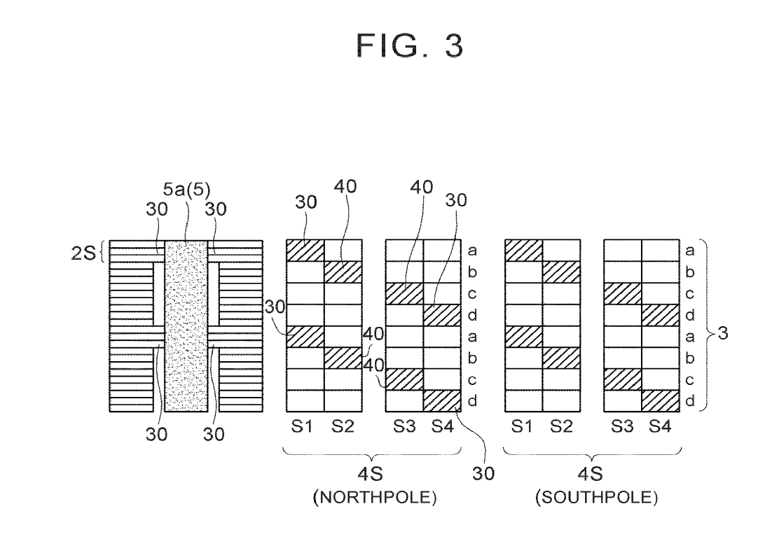

The rotor 1 includes a stacked body 3 (see FIG. 3) and magnets 5. The stacked body 3 is formed by stacking, in the extending direction of a rotational axis L, thin stackable steel plates 2 each of which is formed by punching a steel plate coated with an insulation film into a disk shape. The magnets 5 are disposed in magnet insertion holes 4 punched in each stackable steel plate 2 having a disk shape. Each stackable steel plate 2 has an opening 8 through which a rotary shaft 7 is passed, and a pair of keys 4a fitted in key grooves 7a formed in the rotary shaft 7. The keys 4a are formed at the peripheral edge of the opening 8 so as to project toward the rotational axis L. The two keys 4a are disposed at positions that are apart from each other by a phase angle of 180°. At a cutting surface of each steel plate coated with an insulation film, the insulation film is likely to peel off due to punching of the steel plate coated with an insulation film.

In the rotor 1, the south poles and the north poles are alternately arranged in the circumferential direction of the rotor 1. Further, at each of the magnetic poles, four magnets 5a, 5b, 5c, 5d are disposed in the magnet insertion hole 4. The magnet insertion hole 4 provided in each magnetic pole has a first magnet insertion portion 10 and a second magnet insertion portion 20 that are in the form of slits obliquely extending inward from the outer peripheral side of the stackable steel plate 2. Each magnet insertion hole 4 has an inverted V-shape having an apex P oriented toward the rotational axis L.

A first magnet 5a and a second magnet 5b are disposed in the first magnet insertion portion 10, and a third magnet 5c and a fourth magnet 5d are disposed in the second magnet insertion portion 20. The first magnet 5a and the second magnet 5b are subjected to mold forming in a contact state. The third magnet 5c and the fourth magnet 5d are also subjected to mold forming in a contact state. The first to fourth magnets 5a to 5d in each set are magnetized so as to have the same polarity, and the magnets having the same polarity are disposed in each magnet insertion hole 4 in an inverted V-shape. The first magnet insertion portions 10 and the second magnet insertion portions 20 are formed by punching.

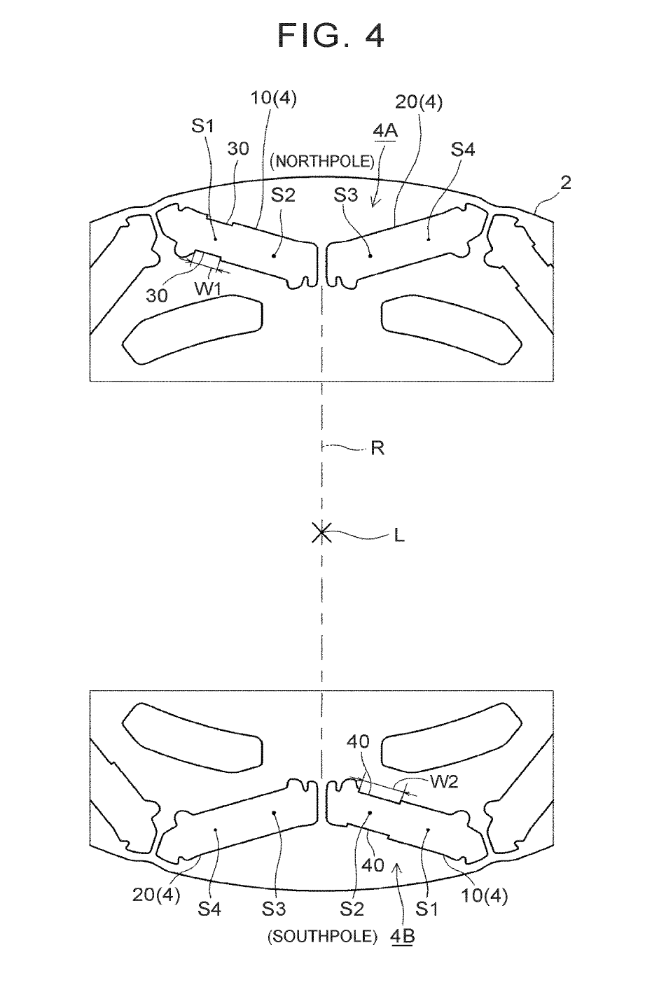

As illustrated in FIG. 2 and FIG. 4, each first magnet insertion portion 10 of the stackable steel plate 2 has a first magnet insertion half-part S1 and a second magnet insertion half-part S2 located inward of the first magnet insertion half-part S1. The first magnet 5a is disposed in the first magnet insertion half-part S1, and the second magnet 5b is disposed in the second magnet insertion half-part S2. Similarly, each second magnet insertion portion 20 has a third magnet insertion half-part S3 and a fourth magnet insertion half-part S4 located outward of the third magnet insertion half-part S3. The third magnet 5c is disposed in the third magnet insertion half-part S3, and the fourth magnet 5d is disposed in the fourth magnet insertion half-part S4.

Each of the first to fourth magnets 5a to 5d having the same shape is in the form of a rectangular block extending along the rotational axis L. Each stackable steel plate 2 has the first to fourth magnet insertion half-parts S1 to S4. The stackable steel plates 2 are stacked in the direction of the rotational axis L to constitute the stacked body 3. At this time, each of the first and second magnet insertion portions 10, 20 continuously extends along the rotational axis L in the stacked body 3.

Each stackable steel plate 2 has several pairs of magnet insertion holes 4A, 4B. The magnet insertion holes 4A, 4B in each pair are located at positions that are symmetric with respect to the rotational axis L. The peripheral edge of the first magnet insertion half-part Si of each magnet insertion hole 4A is provided with a pair of first projections 30 that project toward the first magnet 5a. The first projections 30 in each pair are disposed so as to be opposed to each other, thereby holding the first magnet 5a from both sides. Holding the first magnet 5a between the first projections 30 that are opposed to each other makes it possible to reduce the area of contact between the first magnet 5a and each stackable steel plate 2, thereby reliably fixing the magnet 5 in the magnet insertion hole 4.

The distal end of each first projection 30 is a cut surface, and thus the insulation film peels off at the distal end. The exposed surface at the distal end of each first projection 30 is in direct contact with the first magnet 5a, but is not in contact with the second magnet 5b, so that conduction between the first magnet 5a and the second to fourth magnets 5b, 5c, 5d is avoided. This configuration contributes to reduction in eddy current losses generated in the surface.

Although not illustrated in the drawings, the configuration where only one of the first projections 30 is disposed may be employed, instead of the configuration where the first projections 30 are disposed so as to be opposed to each other. In this case, the first magnet 5a may be held between the first projection 30 and a flat peripheral edge portion of the first magnet insertion half-part S1.

Similarly, the peripheral edge of the second magnet insertion half-part S2 of each magnet insertion hole 4B of each stackable steel plate 2 is provided with a pair of second projections 40 that project toward the second magnet 5b. The second projections 40 in each pair are disposed so as to be opposed to each other, thereby holding the second magnet 5b from both sides. Holding the second magnet 5b between the second projections 40 that are opposed to each other makes it possible to reduce the area of contact between the second magnet 5b and each stackable steel plate 2, thereby reliably fixing the magnet 5 in the magnet insertion hole 4.

The distal end of each second projection 40 is a cut surface, and thus the insulation film peels off at the distal end. The exposed surface at the distal end of each second projection 40 is in direct contact with the second magnet 5b, but is not in contact with the first magnet 5a, so that conduction between the second magnet 5b and the first, third and fourth magnets 5a, 5c, 5d is avoided. This configuration contributes to reduction in eddy current losses generated in the surface.

Although not illustrated in the drawings, the configuration where only one of the second projections 40 is disposed may be employed, instead of the configuration where the second projections 40 are disposed so as to be opposed to each other. In this case, the second magnet 5b may be held between the second projection 40 and a flat peripheral edge portion of the second magnet insertion half-part S2.

In the circumferential direction of each stackable steel plate 2, the first projections 30 are disposed in one half of the circumference of the stackable steel plate 2, and the second projections 40 are disposed in the remaining half of the circumference of the stackable steel plate 2 (see FIG. 1). Specifically, in the circumferential direction of each stackable steel plate 2, five pairs of the first projections 30 are consecutively arranged side by side, and five pairs of the second projections 40 are consecutively arranged side by side.

When the stackable steel plates 2 with the first projections 30 and the second projections 40 having the above-described relationship are employed, the first and the second projections 30, 40 are arranged at positions as illustrated in FIG. 3 by rotating some of the stackable steel plates 2 of a single kind by 180° about the rotational axis L, or turning over some of the stackable steel plates 2. In a practical use, the stackable steel plates 2 are used in the form of a stackable steel plate group 2S formed by stacking multiple (three, in this case) steel plates 2 (see FIG. 3). In this case, the stackable steel plates 2 are stacked such that the magnet insertion holes 4 of the stackable steel plates 2 are arranged consecutively along the rotational axis L. Thus, magnet insertion holes 4S (see FIG. 3) extending along the rotational axis L are formed in the stacked body 3.

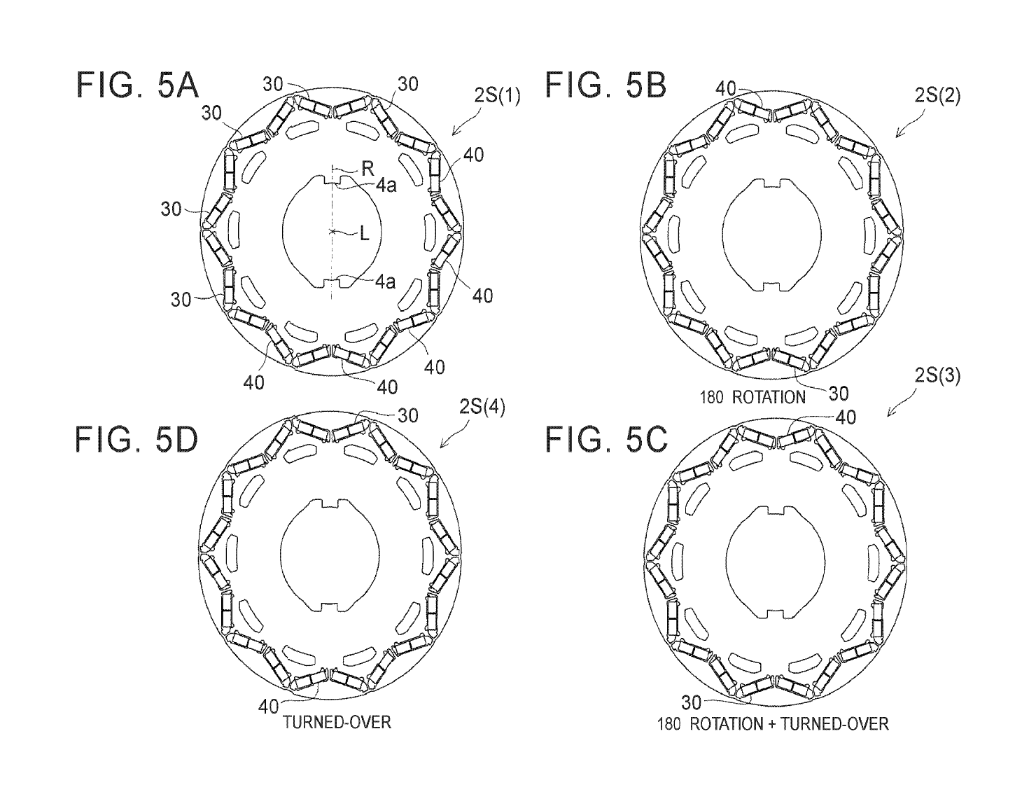

A stackable steel plate group 2S(1) illustrated in FIG. 5A is in a state in which three stackable steel plates 2 illustrated in FIG. 1 are stacked. In the following description, the stackable steel plate group 2S(1) is used as a reference stackable steel plate group.

A stackable steel plate group 2S(2) illustrated in FIG. 5B is in a state in which the stackable steel plate group 2S(1) is rotated by 180° about the rotational axis L.

A stackable steel plate group 2S(4) illustrated in FIG. 5D is in a state in which the stackable steel plate group 2S(1) is turned over around a reference axial line R extending through the centers of the keys 4a. The turn-over is not limited to a turn-over around the reference axial line R extending through the centers of the keys 4a, and the stackable steel plate group 2S may be turned over around a reference axial line (not illustrated) extending through the centers of the magnet insertion holes 4A, 4B that are on the opposite sides with respect to the rotational axis L.

A stackable steel plate group 2S(3) illustrated in FIG. 5C is in a state in which the stackable steel plate group 2S(1) is rotated by 180° about the rotational axis L, and subsequently, is turned over around the reference axial line R extending through the centers of the keys 4a.

The stackable steel plate group 2S(1) is used at a position indicated by a reference symbol “a” in FIG. 3. The stackable steel plate group 2S(2) is used at a position indicated by a reference symbol “b” in FIG. 3. The stackable steel plate group 2S(3) is used at a position indicated by a reference symbol “c” in FIG. 3. The stackable steel plate group 2S(4) is used at a position indicated by a reference symbol “d” in FIG. 3.

In this way, as illustrated in FIG. 3, the first projections 30 are offset from the second projections 40 in the direction of the rotational axis L. Further, the first and second projections 30, 40 that are adjacent to each other in the circumferential direction are arranged in a stepwise manner in each magnet insertion hole 4S in the stacked body 3. This configuration contributes to reduction in eddy current losses generated in the direction of the rotational axis L. In the direction of the rotational axis L, each of the first to fourth magnets 5a to 5d is held by the first projections 30 that are disposed at two positions, that is, an upper position and a lower position, or held by the second projections 40 that are disposed at two positions, that is, an upper position and a lower position. With this configuration, each of the first to fourth magnets 5a to 5d is stably held by the first projections 30 or the second projections 40 in the magnet insertion hole 4S.

The invention is made by focusing on the feature that, in the stackable steel plates 2 of the rotor 1, the four magnets 5a to 5d are disposed at each magnetic pole, and the keys 4a are disposed at positions that are apart from each other by a phase angle of 180°. In this case, each magnet insertion hole 4 has the first magnet insertion portion 10 and the second magnet insertion portion 20 that are formed as slits, each magnet insertion hole 4 has an inverted V-shape, and each magnet insertion hole 4 is divided into two portions, that is, the first magnet insertion portion 10 and the second magnet insertion portion 20. The first magnet insertion portion 10 has the first magnet insertion half-part S1 and the second magnet insertion half-part S2 located inward of the first magnet insertion half-part S1, and the second magnet insertion portion 20 has the third magnet insertion half-part S3 and the fourth magnet insertion half-part S4 located outward of the third magnet insertion half-part S3.

Each magnet insertion hole 4 having the first magnet insertion portion 10 and the second magnet insertion portion 20 is provided with the first projections 30 or the second projections 40. Further, in each magnet insertion hole 4, the projections 30 or the projections 40 are provided at only one of the four parts, that is, the first to fourth magnet insertion half-parts S1 to S4. This makes it possible to reduce eddy current losses.

Further, each stackable steel plate 2 has several pairs of the magnet insertion holes 4A, 4B. The magnet insertion holes 4A, 4B in each pair are located at positions that are symmetric with respect to the rotational axis L. The peripheral edge of the first magnet insertion half-part S1 of each magnet insertion hole 4A is provided with a pair of the first projections 30 that project toward the first magnet 5a. The peripheral edge of the second magnet insertion half-part S2 of each magnet insertion hole 4B is provided with a pair of the second projections 40 that project toward the second magnet 5b. As a result, when the stackable steel plates 2 are stacked, the first and second projections 30, 40 that are adjacent to each other in the circumferential direction are arranged at the positions that are offset from each other in the extending direction of the rotational axis L, so that the eddy current losses are reduced. This configuration is achieved by turning over the reference stackable steel plates 2 (see the stackable steel plate group 2S(1)), rotating the reference stackable steel plates 2 by 180° about the rotational axis L, or rotating the reference stackable steel plates 2 by 180° about the rotational axis L, and subsequently, turning over the reference stackable steel plates 2 around the reference axial line R extending through the centers of the keys 4a. Thus, it is no longer necessary to prepare many kinds of the stackable steel plates 2 based on the number of the positions where the projections 30, 40 are arranged. This makes it possible to simplify the process of manufacturing the rotor 1 and to reduce the cost of manufacturing the rotor 1.

A second embodiment of the invention will be described below. In the second embodiment, the same reference symbols will be used for elements that are the same as or corresponding to those in the first embodiment, and the details of these elements will be omitted from the following description.

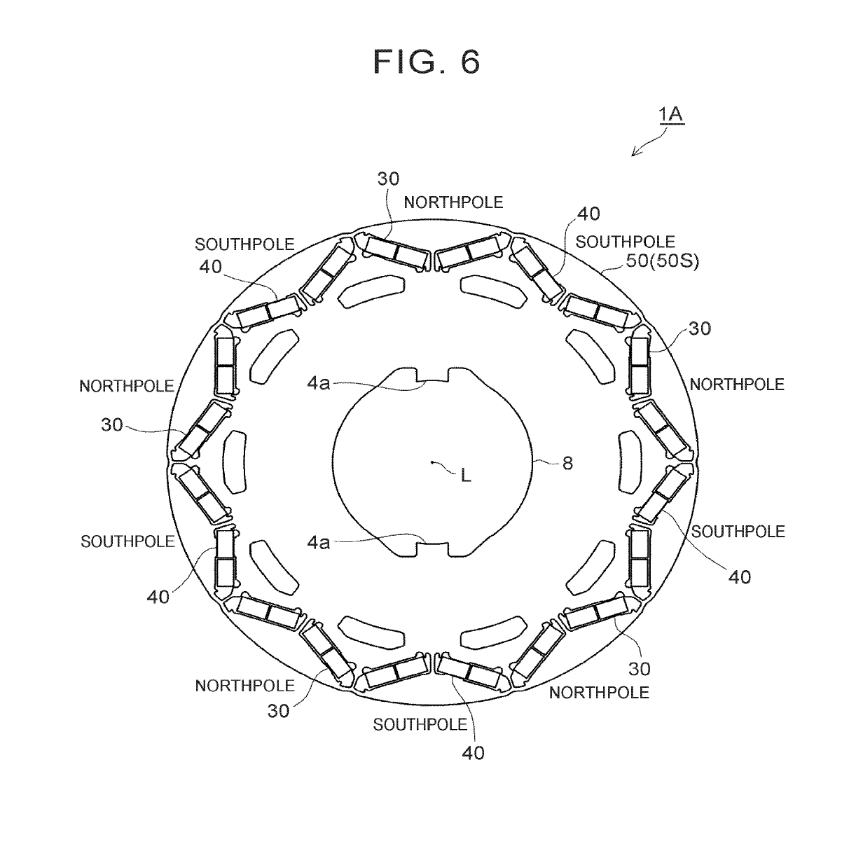

The second embodiment is different from the first embodiment in that, in a rotor 1A illustrated in FIG. 6, first projections 30 and second projections 40 are arranged alternately in the circumferential direction of each of stackable steel plates 50 that constitute a stackable steel plate group 50S.

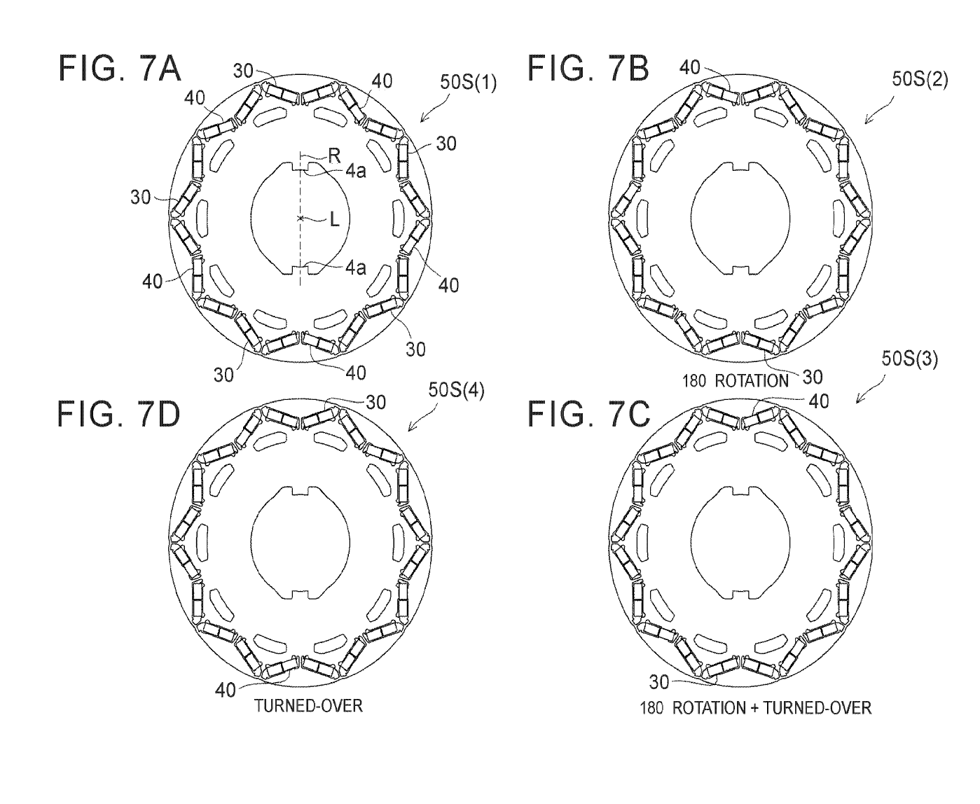

A stackable steel plate group 50S(1) illustrated in FIG. 7A is in a state in which three stackable steel plates 50 illustrated in FIG. 6 are stacked. In the following description, the stackable steel plate group 50S(1) is used as a reference stackable steel plate group.

A stackable steel plate group 50S(2) illustrated in FIG. 7B is in a state in which the stackable steel plate group 50S(1) is rotated by 180° about the rotational axis L. The stackable steel plate group 50S(2) corresponds to the stackable steel plate group 2S(2) illustrated in FIG. 5B in the first embodiment.

A stackable steel plate group 50S(4) illustrated in FIG. 7D is in a state in which the stackable steel plate group 50S(1) is turned over around the reference axial line

R extending through the centers of the keys 4a. The stackable steel plate group 50S(4) corresponds to the stackable steel plate group 2S(4) illustrated in FIG. 5D in the first embodiment.

A stackable steel plate group 50S(3) illustrated in FIG. 7C is in a state in which the stackable steel plate group 50S(1) is rotated by 180° about the rotational axis L, and subsequently, is turned over around the reference axial line R extending through the centers of the keys 4a. The stackable steel plate group 50S(3) corresponds to the stackable steel plate group 2S(3) illustrated in FIG. 5C in the first embodiment.

As is apparent from the above description, using the stackable steel plates 50 makes it possible to produce the same advantageous effects as those produced by using the stackable steel plates 2 according to the first embodiment.

The invention is not limited to the foregoing embodiments, and various modifications described below may be made within the scope of the invention.

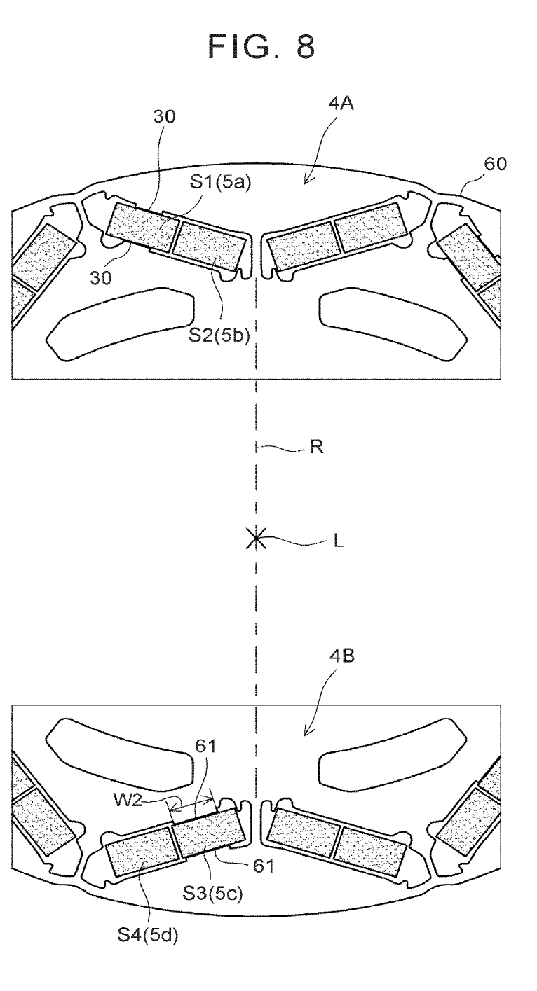

As illustrated in FIG. 8, each stackable steel plate 60 has several pairs of magnet insertion holes 4A, 4B. The magnet insertion holes 4A, 4B in each pair are located at positions that are symmetric with respect to the rotational axis L. The peripheral edge of a first magnet insertion half-part S1 of each magnet insertion hole 4A is provided with a pair of first projections 30 that project toward the first magnet 5a. The peripheral edge of a third magnet insertion half-part S3 of each magnet insertion hole 4B is provided with a pair of second projections 61 that project toward the third magnet 5c. As a result, when the stackable steel plates 60 having the above configuration are stacked, the first and second projections 30, 61 that are adjacent to each other in the circumferential direction are arranged at various positions that are offset from each other in the extending direction of the rotational axis L. This configuration is achieved by rotating the reference stackable steel plates 60 by 180° about the rotational axis L, turning over the reference stackable steel plates 60, or rotating the reference stackable steel plates 60 by 180° about the rotational axis L, and subsequently, turning over the reference stackable steel plates 60 around the reference axial line R extending through the centers of the keys 4a.

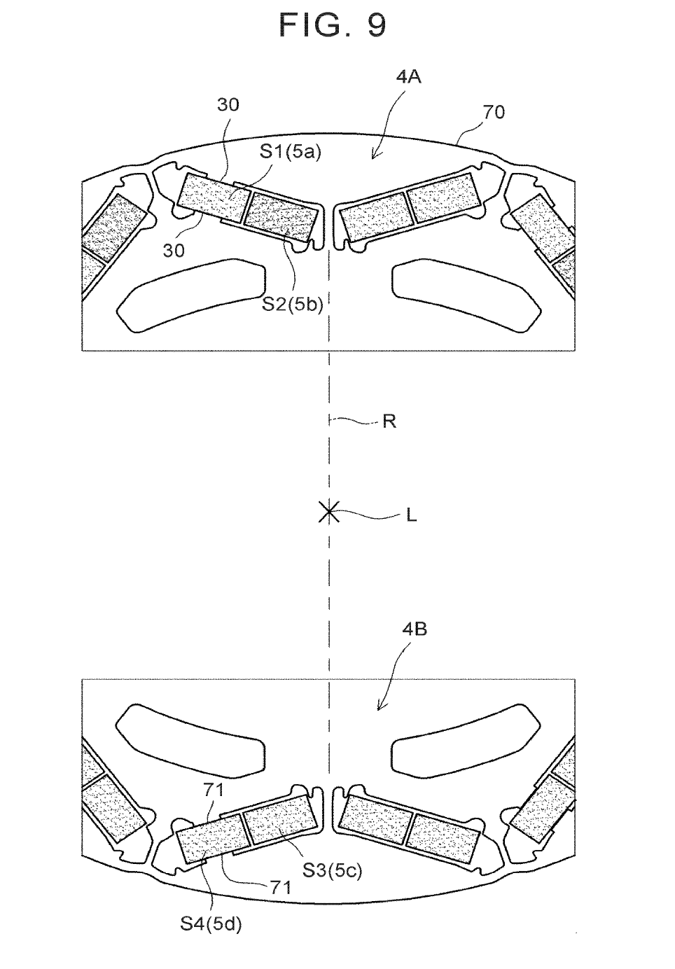

As illustrated in FIG. 9, each stackable steel plate 70 has several pairs of magnet insertion holes 4A, 4B. The magnet insertion holes 4A, 4B in each pair are located at positions that are symmetric with respect to the rotational axis L. The peripheral edge of a first magnet insertion half-part S1 of each magnet insertion hole 4A is provided with a pair of first projections 30 that project toward the first magnet 5a. The peripheral edge of a fourth magnet insertion half-part S4 of each magnet insertion hole 4B is provided with a pair of second projections 71 that project toward the fourth magnet 5d. As a result, when the stackable steel plates 70 having the above configuration are stacked, the first and second projections 30, 71 that are adjacent to each other in the circumferential direction are arranged at various positions that are offset from each other in the extending direction of the rotational axis L. This configuration is achieved by rotating the reference stackable steel plates 70 by 180° about the rotational axis L, turning over the reference stackable steel plates 70, or rotating the reference stackable steel plates 70 by 180° about the rotational axis L, and subsequently, turning over the reference stackable steel plates 70 around the reference axial line R extending through the centers of the keys 4a.

As described above, the second projections 40, 61 are located inward of the first projections 30. Thus, as illustrated in FIG. 4 and FIG. 8, a length W1 of each first projection 30 may be shorter than a length W2 of each second projection 40, 61. The projections 30, 40, 61 may have an adverse effect on the weight balance of the rotor 1 during rotation. Hence, the length W1 of each first projection 30 located outward of the second projection 40, 61 is set shorter than the length W2 of each second projection 40, 61 located inward of the first projection 30, so that the adverse effect on the weight balance due to the projections 30, 40, 61 can be reduced. Particularly, when the number of stackable steel plates used in each stackable steel plate group varies among the stackable steel plate groups, unbalance is likely to be caused during the rotation. Thus, this configuration is particularly effective.

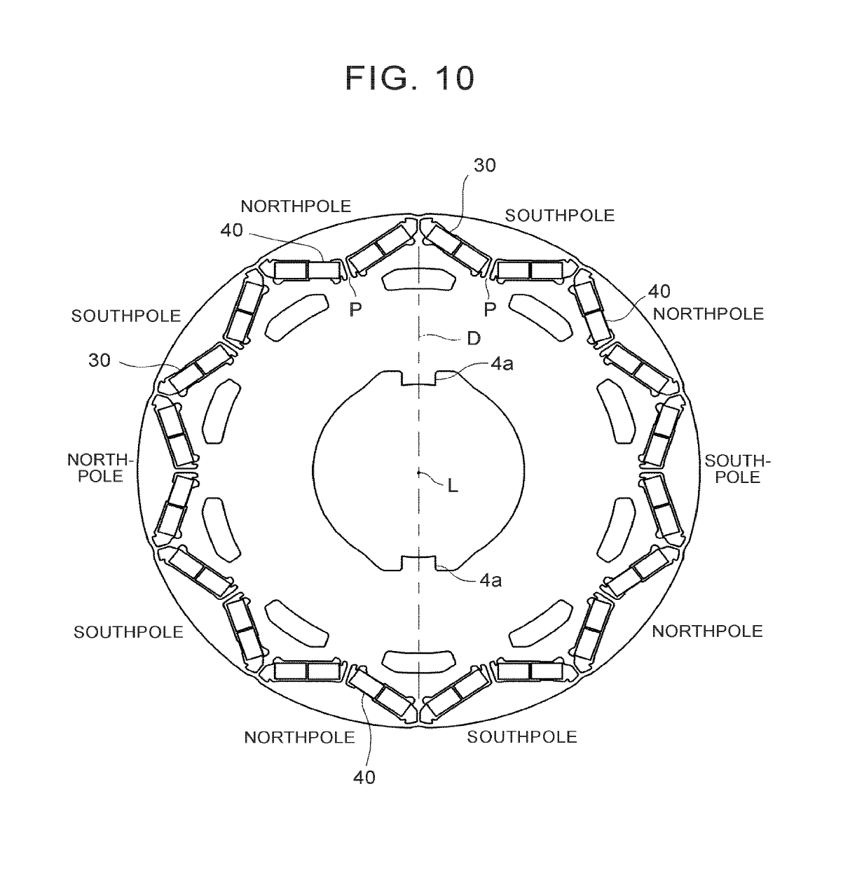

The positions of the keys 4a are not limited to the positions on a line D connecting the apexes P of the inverted V-shaped magnet insertion holes to the rotational axis L as illustrated in FIG. 1, and may be positions on a line connecting the rotational axis L to points each located between the south pole and the north pole as illustrated in FIG. 10.

Each magnet 5 need not be divided into multiple pieces, or may be divided into two or more pieces.

The first magnet insertion portion 10 and the second magnet insertion portion 20 need not be arranged in an inverted V-shape, or the first magnet insertion portion 10 and the second magnet insertion portion 20 may be arranged in line in the circumferential direction.

Each magnet insertion hole 4 need not be divided into the first magnet insertion portion 10 and the second magnet insertion portion 20.

The stacked body 3 may be formed in any manner as long as the following conditions are satisfied. The stackable steel plates 2 (50; 60; 70) that constitute the stacked body 3 include a first stackable steel plate 2 (50; 60; 70) and a second stackable steel plate 2 (50; 60; 70), the first stackable steel plate 2 (50; 60; 70) and the second stackable steel plate 2 (50; 60; 70) having the same shape. The stackable steel plates 2 (50; 60; 70) are stacked such that the second stackable steel plate 2 (50; 60; 70) is in one of a first relationship, a second relationship, and a third relationship with the first stackable steel plate 2 (50; 60; 70), and the projections 30, 40 (30, 61; 30, 71) located adjacent to each other in the circumferential direction are arranged at positions offset from each other in a stacking direction of the stackable steel plates 2 (50; 60; 70). The first relationship is a relationship achieved by rotating the second stackable steel plate 2 (50; 60; 70) about the rotational axis (L) from a position of the first stackable steel plate 2 (50; 60; 70). The second relationship is a relationship achieved by turning over the second stackable steel plate 2 (50; 60; 70) from the position of the first stackable steel plate 2 (50; 60; 70). The third relationship is a relationship achieved by rotating the second stackable steel plate 2 (50; 60; 70) about the rotational axis (L) from the position of the first stackable steel plate 2 (50; 60; 70) and turning over the second stackable steel plate 2 (50; 60; 70).

What is clamed is:

1. A rotor comprising:
a stacked body including stackable steel plates stacked in an extending direction of a rotational axis, each of the stackable steel plates being formed by punching multiple magnet insertion holes in a steel plate coated with an insulation film at regular intervals in a circumferential direction of the stackable steel plate; and
magnets disposed in the magnet insertion holes, wherein
a peripheral edge of each of the magnet insertion holes is provided with a projection that projects toward a corresponding one of the magnets,
the stackable steel plates that constitute the stacked body include a first stackable steel plate and a second stackable steel plate, the first stackable steel plate and the second stackable steel plate having the same shape, and
the stackable steel plates are stacked such that the second stackable steel plate is in one of a first relationship, a second relationship, and a third relationship with the first stackable steel plate, and the projections located adjacent to each other in the circumferential direction are arranged at positions offset from each other in a stacking direction of the stackable steel plates,
the first relationship being a relationship achieved by rotating the second stackable steel plate about the rotational axis from a position of the first stackable steel plate,
the second relationship being a relationship achieved by turning over the second stackable steel plate from the position of the first stackable steel plate, and
the third relationship being a relationship achieved by rotating the second stackable steel plate about the rotational axis from the position of the first stackable steel plate and turning over the second stackable steel plate.

2. The rotor according to claim 1, wherein:
each of the magnet insertion holes includes a pair of a first magnet insertion portion and a second magnet insertion portion that are adjacent to each other; and
the projection in each of the magnet insertion holes is located in one of the first magnet insertion portion and the second magnet insertion portion.

3. The rotor according to claim 2, wherein each of the magnet insertion holes includes the first magnet insertion portion and the second magnet insertion portion that are in form of slits obliquely extending inward from an outer peripheral side of the stackable steel plate such that each of the magnet insertion holes has an inverted V-shape having an apex oriented toward the rotational axis.

4. The rotor according to claim 3, wherein:
each of the first magnet insertion portions includes a first magnet insertion half-part and a second magnet insertion half-part located inward of the first magnet insertion half-part;
each of the second magnet insertion portions includes a third magnet insertion half-part and a fourth magnet insertion half-part located outward of the third magnet insertion half-part;
the projections include a first projection and a second projection;
the magnet insertion holes include a pair of a first magnet insertion hole and a second magnet insertion hole that are located at positions symmetric with respect to the rotational axis;
a peripheral edge of the first magnet insertion half-part of the first magnet insertion hole is provided with the first projection that projects toward a corresponding one of the magnets; and
a peripheral edge of the second magnet insertion half-part, a peripheral edge of the third magnet insertion half-part, or a peripheral edge of the fourth magnet insertion half-part of the second magnet insertion hole is provided with the second projection that projects toward a corresponding one of the magnets.

5. The rotor according to claim 4, wherein:
in the circumferential direction of each of the stackable steel plates, the first projections are disposed in one half of a circumference of each of the stackable steel plates, and the second projections are disposed in the remaining half of the circumference of each of the stackable steel plates; and
each of the second projections is located in the second magnet insertion half-part or the third magnet insertion half-part.

6. The rotor according to claim 4, wherein:
the first projections and the second projections are arranged alternately in the circumferential direction of each of the stackable steel plates; and
each of the second projections is located in the second magnet insertion half-part or the third magnet insertion half-part.

7. The rotor according to claim 1, wherein:
the peripheral edge of each of the magnet insertion holes is provided with a pair of the projections that are opposed to each other such that a corresponding one of the magnets is held between the projections.

8. The rotor according to claim 4, wherein a length of the first projection is shorter than a length of the second projection located in the second magnet insertion half-part or the third magnet insertion half-part.
